(19) United States
(12) Patent Application Publication
(10) Pub. No.: US 2015/0029110 A1
(43) Pub. Date: Jan. 29, 2015

(54) Symbol-Oriented Touch Screen Device

(71) Applicant: Wen-Fu Chang, Hsinchu City (TW)

(72) Inventor: Wen-Fu Chang, Hsinchu City (TW)

(21) Appl. No.: 14/201,277

(22) Filed: Mar. 7, 2014

(30) Foreign Application Priority Data
Jul. 25, 2013 (TW) 102214048

(51) Int. Cl. G06F 3/041; H04M 1/725; G06F 3/0484; G06F 3/0481; G06F 3/0488

(52) U.S. Cl. CPC G06F 3/0416; G06F 3/0412; G06F 3/04817; G06F 3/0488; G06F 3/04845; H04M 1/72519
USPC 345/173

(57) ABSTRACT

Disclosed is a symbol-oriented touch screen device including a displaying means, a touch control panel, a symbol shape storing means, and a hardware processing means. The touch control panel is coupled to the display means for detecting a sliding trace. The symbol shape storing means is electrically connected to the displaying means and the touch control pane, and stores a symbol shape data in accordance with a page. The hardware processing means, electrically connected to the touch control panel and the symbol shape data storing means, includes a trace recognizing unit and a responding unit. The trace recognizing unit is for recognizing the sliding trace and for generating a recognized result while the sliding trace is matched with the symbol shape data. The responding unit is for performing a dialing action, an answering action, an inquiring action, and a controlling action in accordance with the recognized result.

### CROSS-REFERENCE TO RELATED APPLICATIONS

This application claims the benefit of Taiwanese Application No. 102214048, filed Jul. 25, 2013, in the Taiwan Intellectual Property Office. All disclosures of the document(s) named above are incorporated herein by reference.

### FIELD OF THE INVENTION

The present invention relates to a touch screen device, and more particularly to a touch screen device having a symbol-oriented function.

### BACKGROUND OF THE INVENTION

With the development of technology, a touch control panel has been widely applied as an operating interface for all kinds of touch control devices, including a computer (such as a desktop computer, a notebook computer or a tablet), and a portable device (such as a mobile phone or a personal digital assistant).

A touch control panel is able to detect a touching location on its surface that is being touched by an object (for example a finger or a stylus), and a touch control panel usually is displayed with various icons which are corresponding to respective operations such as dialing, answering, inquiring or controlling. A user can tap the different icons for every contact person so as to perform an operation of dialing, answering, inquiring or controlling.

However, in the above conventional touch control device, a user may have to spend plenty of time and efforts to look for a icon for a specific contact person, if an operation of dialing, answering, inquiring or controlling is desired. Such operating process is not only not intuitive for a user, but it is rather complicated and inconvenient.

### SUMMARY OF THE INVENTION

Accordingly, an aspect of the present invention is to provide a symbol-oriented touch screen device to solve the problems.

The symbol-oriented touch screen device of the present invention includes a displaying means, a touch control panel, a symbol shape storing means, and a hardware processing means. The displaying means is provided with a viewing area for displaying a page. The touch control panel is coupled to the display means for detecting a sliding trace of a user's finger on the touch control panel. The symbol shape storing means is electrically connected to the displaying means and the touch control panel, and stores a symbol shape data in accordance with the page. The symbol shape data is for determining shapes of a plurality of symbol elements. The hardware processing means includes a trace recognizing unit and a responding unit. The trace recognizing unit is provided for recognizing whether the sliding trace is matched with a shape of the symbol element or not based on the symbol shape data, and generates a recognized result accordingly. The responding unit is electrically connected to the trace recognizing unit for performing a dialing action, an answering action, an inquiring action, and a controlling action in accordance with the recognized result.

According to an embodiment of the present invention, the symbol element is with a frame-shape, a bar-shape, a dot-shape, a polygon-shape, a heart-shape, a circle-shape, a cross-shape, a hook-shape, or an arrow-shape.

According to an embodiment of the present invention, the symbol element is displayed or hidden in the touch control panel.

According to an embodiment of the present invention, the trace recognizing unit includes a trace direction recognizing component for recognizing a direction of a sliding symbol of the sliding trace sliding across the symbol element.

According to an embodiment of the present invention, it further comprises a position storing means for storing a symbol position data of the symbol element, the symbol position data is for determining the position of the symbol element, and the recognized result is generated according to a position relationship between the sliding trace and the symbol element by the trace recognizing unit.

According to an embodiment of the present invention, it further comprising a zooming unit electrically connected to the trace recognizing unit, the zooming unit performs a zooming operation according to a position of the sliding trace recognized by the trace recognizing unit.

According to an embodiment of the present invention, the inquiring action is performed by the responding unit to inquire information including an unanswered call and a communication history when the slide trace is matched with an inquiring symbol of the symbol element.

According to an embodiment of the present invention, the controlling action includes a control of volume adjustment by the responding unit when the sliding trace is matched with a symbol element of volume adjustment.

By means of technical means of the present invention, it can reduce both the searching time for a contacting person and input error ratio as well by recognizing whether a sliding trace of a user's finger is corresponding to a shape of a symbol element with respect to a contacting person. The symbol-oriented touch screen device of the present invention is intuitive and is easy for operation, by which it allows a user to draw the shape of a symbol element rapidly, accurately and easily, so that the trace recognizing unit can generate a recognized result based on the drawn shape, and the symbol-oriented touch screen device can then execute the dialing, answering, and inquiring actions rapidly according to the recognized result.

### BRIEF DESCRIPTION OF THE DRAWINGS

The structure and the technical means adopted by the present invention to achieve the above and others can be best understood by referring to the following detailed description of the preferred embodiments and the accompanied drawings.

FIG. 1A is a schematic diagram illustrating a touch screen device according to an embodiment of the present invention;

FIG. 1B is a schematic diagram illustrating an application of the touch control device according to an embodiment of the present invention;

FIG. 2 is a block diagram illustrating a touch control device according to an embodiment of the present invention;

FIG. 3 is a flowchart illustrating a touch control device according to an embodiment of the present invention;

FIG. 4 is a schematic diagram illustrating a symbol element of the touch control device according to another embodiment of the present invention;

FIGS. 5A-5C are schematic diagrams illustrating an application of the symbol element of the touch control device according to another embodiment of the present invention;

FIGS. 6A-6B are schematic diagrams illustrating an application of the symbol element of the touch control device according to another embodiment of the present invention;

FIGS. 7A-7B are schematic diagrams illustrating an application of the symbol element of the touch control device according to another embodiment of the present invention;

FIG. 8 is schematic diagram illustrating an application of the symbol element of the touch control device according to another embodiment of the present invention;

FIGS. 9A-9B are schematic diagrams illustrating an application of the symbol element of the touch control device according to another embodiment of the present invention;

FIGS. 10A-10k are schematic diagrams illustrating symbol elements of the touch control device according to embodiments of the present invention.

### DETAILED DESCRIPTION OF THE PREFERRED EMBODIMENTS

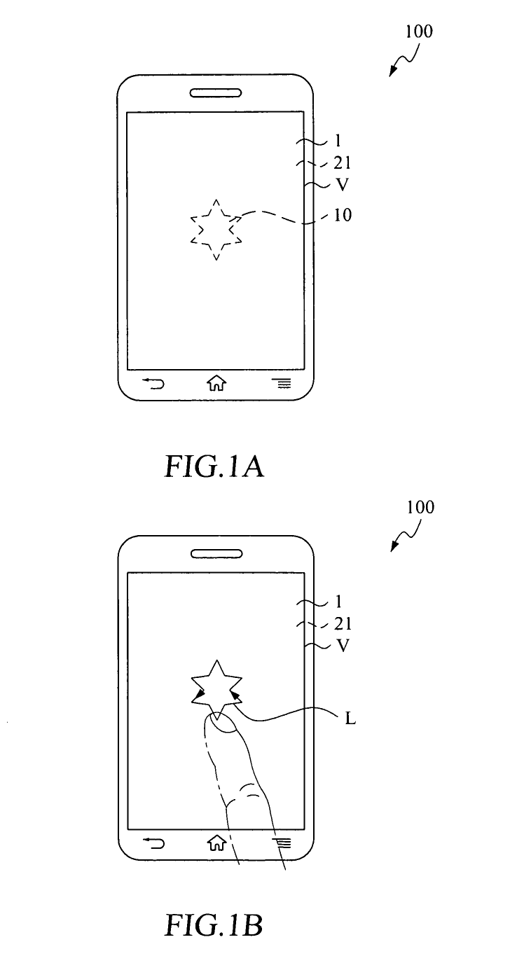

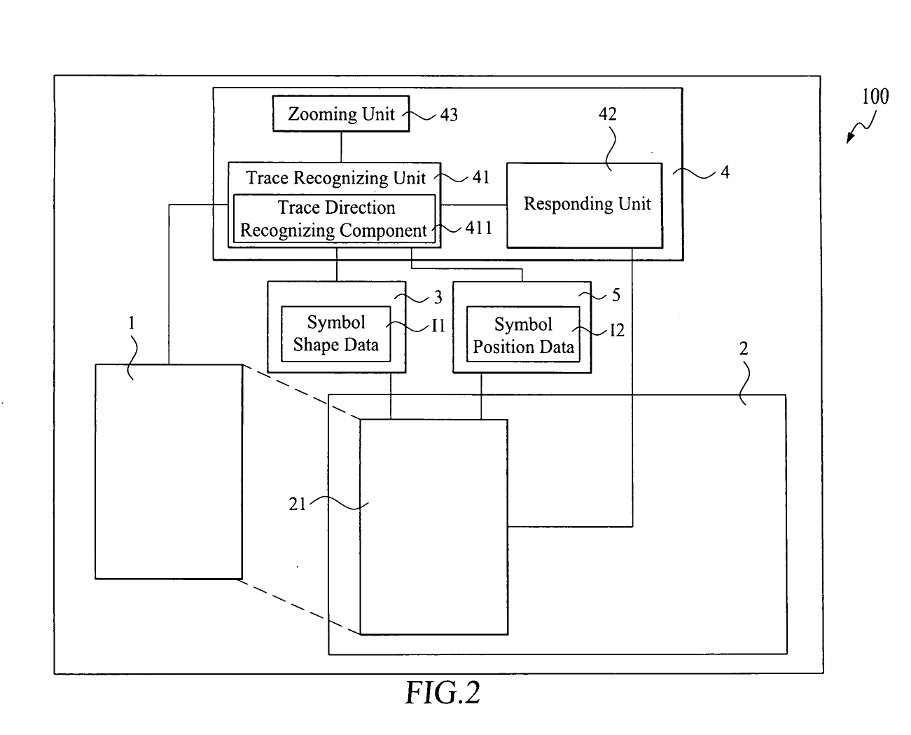

As referring to FIGS. 1A, 1B, and FIG. 2, a symbol-oriented touch screen device 100 of the present invention includes a displaying means 1, an input/output means 2, a symbol shape storing means 3, and a hardware processing means 4.

A touch control panel 21 of the input/output means 2 is coupled to the displaying means 1 and is allocated on the displaying means 1. The display means 1 has a visible area V for displaying a page. In this embodiment, the display means 1 is a screen, and the touch panel 21 is a transparent glass capacitance touch panel. The page within the visible area V of the display means 1 can be displayed through the touch panel 21. In other embodiments, the touch panel 21 also can be a resistance touch panel, an infrared ray touch panel, or the like.

The symbol shape storing means 3 is electrically connected to the displaying means 1 and the touch control panel 21, and the symbol shape storing means 3 stores a symbol shape data I1 in accordance with the page, the symbol shape data I1 is for determining shapes of a plurality of symbol elements 10.

The hardware processing mean 4 is electrically connected to the touch control panel 21 and the symbol shape data storing means 3. The hardware processing means 4 includes a trace recognizing unit 41 and a responding unit 42. The trace recognizing unit 41 is provided for recognizing a sliding trace L of a user's finger and for generating a recognized result when the sliding trace L is matched with a shape of the symbol element 10. The responding unit 42 is electrically connected to the trace recognizing unit 41 for performing a dialing action, an answering action, an inquiring action, and a controlling action of the touch screen device 100 in accordance with the recognized result.

A position storing means 5 stores a symbol position data I2 of the symbol element 10. The symbol position data I2 is for determining the position of the symbol element 10. And the recognized result is generated by the trace recognizing unit 41 according to a position relationship between the sliding trace L and the symbol element 10.

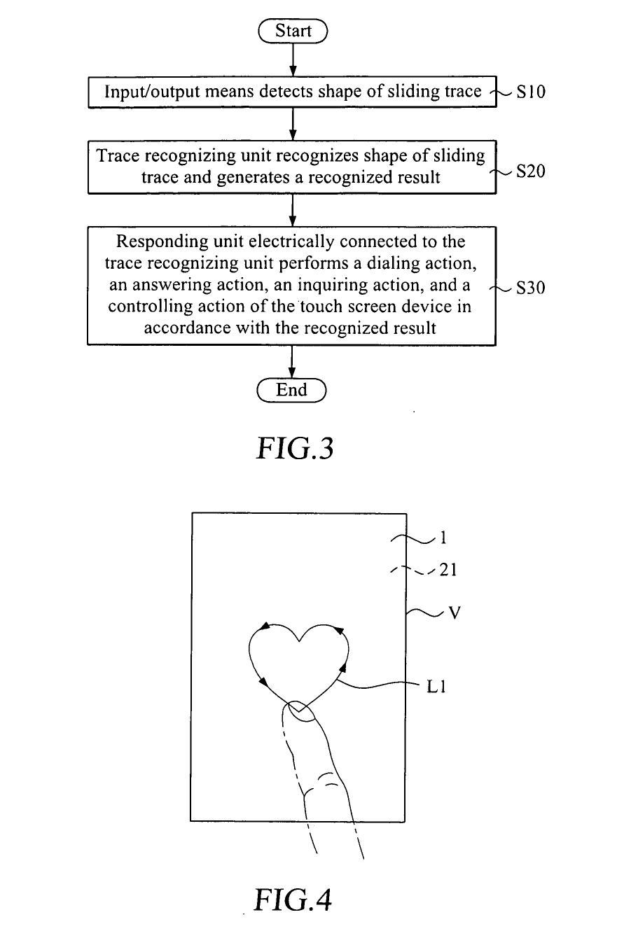

As referring to FIG. 3, FIG. 3 is a flowchart illustrating a touch control device according to an embodiment of the present invention. First, the input/output means 2 detects the shape of the sliding trace (step S10). The trace recognizing unit recognizes the shape of the sliding trace and generates a recognized result (step S20). The responding unit performs a dialing action, an answering action, an inquiring action, and a controlling action of the touch screen device in accordance with the recognized result (step S30).

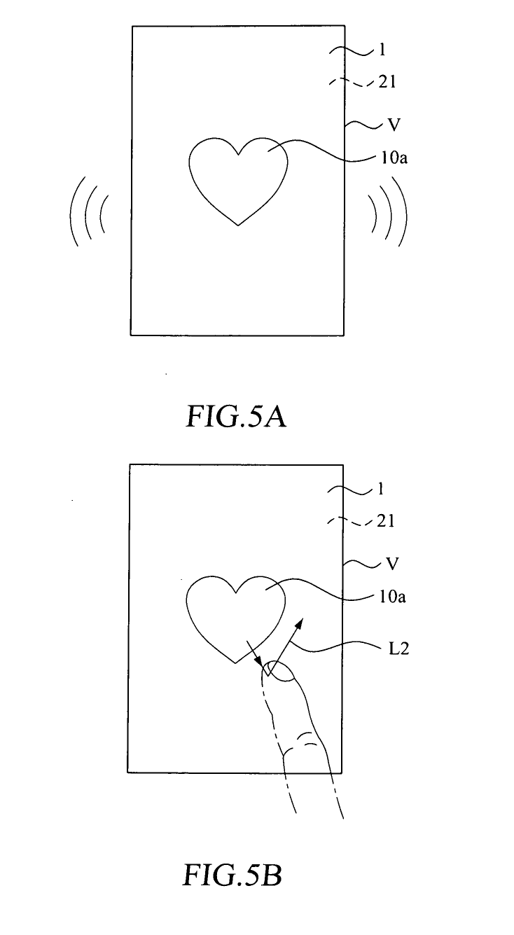

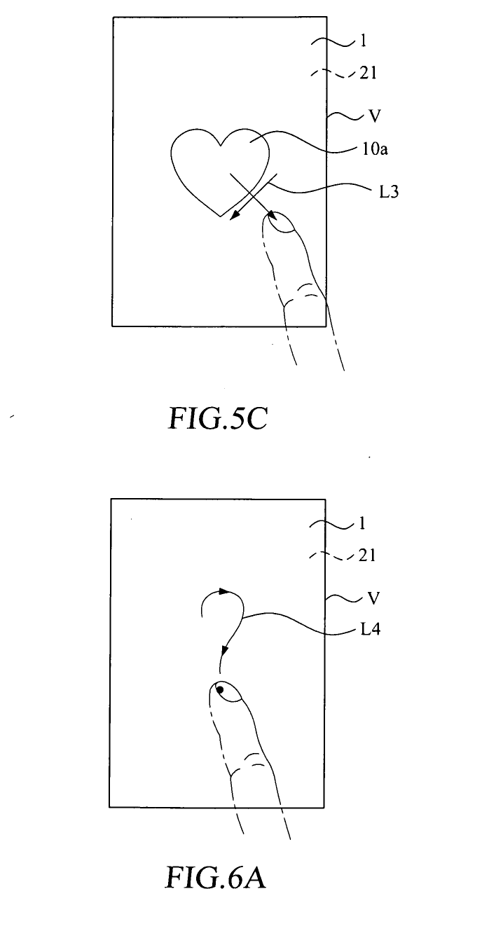

As referring to FIG. 4, a sliding trace L1 is generated by a user's finger sliding on the touch control panel 21 (step S10). The trace recognizing unit 41 recognizes that the sliding trace L1 is matched with a heart-shaped symbol element 10a (FIG. 5A) and generates a recognized result (step S20). The responding unit 42 then performs a dialing action of the touch screen device 100 which dials the number of a person (for example, a favorite person) corresponding to the heart-shaped symbol element 10a (step S30).

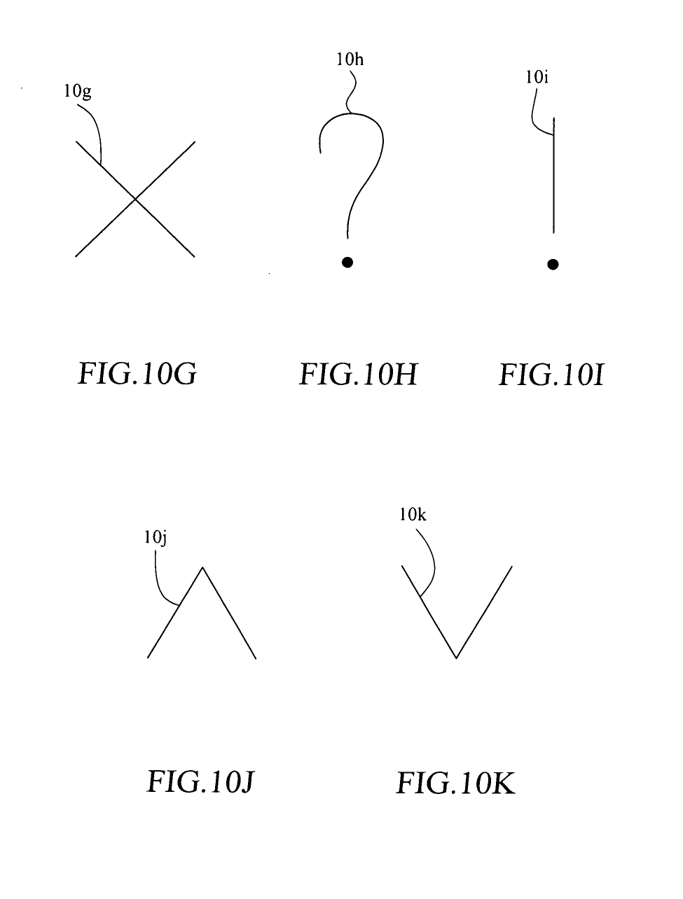

As referring to FIG. 5, the symbol element 10 is commonly hidden in the touch control panel 21. A symbol element 10a is displayed on the touch control panel 21 when the touch screen device 100 receives a call (for example, displaying a heart-shaped symbol element 10a means that a favorite person is calling in): The trace recognizing unit 41 includes a trace direction recognizing component 411 for recognizing a direction of a sliding symbol formed by the sliding trace L sliding across the symbol element 10a. As shown in FIG. 5B, a hook-shaped sliding symbol of the sliding trace L2 is generated by a user's finger sliding across the symbol element 10a. According to the symbol shape data I1, a recognized result is generated by determining whether the sliding trace L2 is matched with a hook-shaped symbol element 10f (FIG. 10F) (step S20). And then the answering action can be performed after the sliding trace L2 is further recognized by the trace direction recognizing component 411 (step S30). In other words, a phone call from the favorite person can be answered. As shown in FIG. 5C, rejecting or hanging up a phone call can be controlled by forming a cross-shaped sliding symbol with a sliding trace L3 of a user's finger, and then a recognized result will be generated by determining whether the sliding trace L3 is matched with a cross-shaped symbol element 10g (FIG. 10G) or not according to the symbol shape data I1 (step S20), and the recognized result is further recognized by the trace direction recognizing component 411 to control answering (step S30).

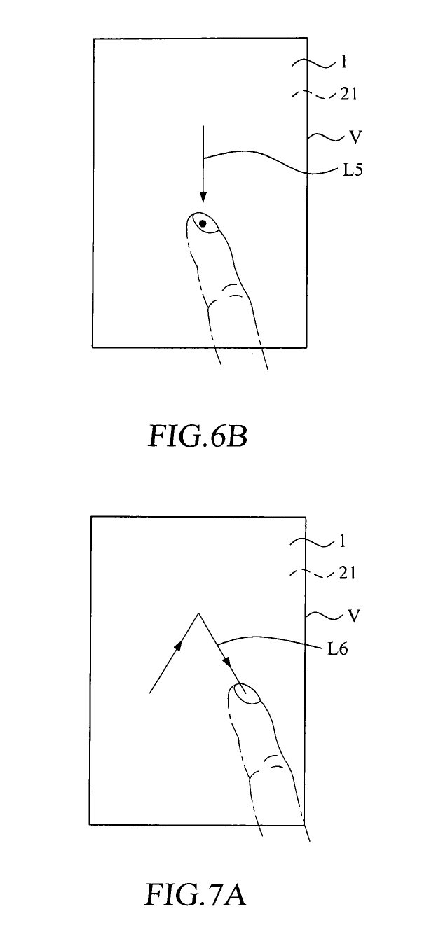

As referring to FIGS. 6A and 6B, they illustrate the inquiring action of the touch screen device 100. A sliding symbol of a sliding trace L4 is formed by a user's finger sliding on the touch control panel 21 (step S10). By determining whether the sliding trace L4 is matched with a question-mark-shaped symbol element 10h (FIG. 10H) or not according to the symbol shape data I1, a recognized result is generated (step S20) and then the responding unit 42 inquiries a communication history (step S30) accordingly. Also, by determining whether the sliding trace L5 is matched with an exclamation-mark-shaped symbol element 10i (FIG. 10I) (step S20) or not according to the symbol shape data I1, a recognized result is generated and then the responding unit 42 inquires unanswered calls (step S30).

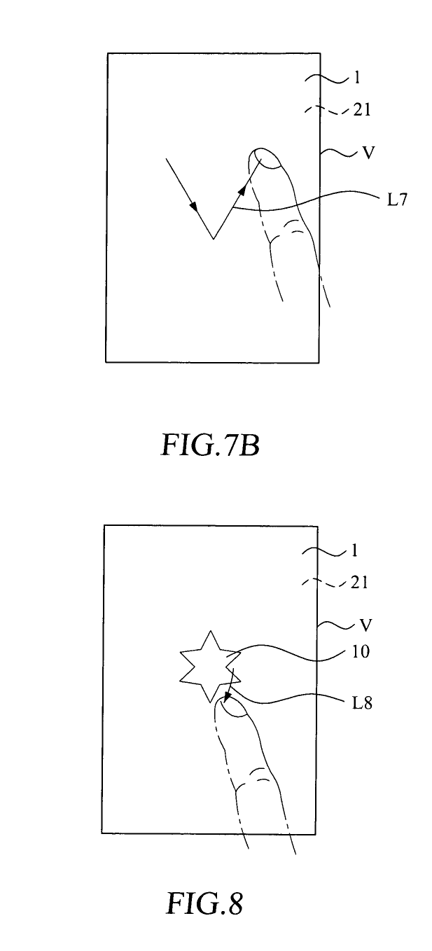

As referring to FIGS. 7A and 7B, they illustrate the controlling action of the touch screen device 100. When the sliding trace L formed by a user's finger sliding on the touch control panel 21 is matched with volume adjustment symbol elements 10j or 10k (FIGS. 10J and 10K) as shown as up-arrow-shaped and down-arrow-shaped symbols, a volume control is performed by the responding unit 42 according to the volume adjustment symbol elements 10j and 10k. A sliding symbol of a sliding trace L6 is formed by a user's finger sliding on the touch control panel 21 (step S10), by determining that the sliding trace L6 is matched with an up-arrow-shaped volume adjustment symbol element 10j (FIG. 10J) according to the symbol shape data I1, and then a recognized result is generated and then the volume will be increased (step S30). Similarly, by determining that the sliding trace L7 is matched with a down-arrow-shaped volume adjustment symbol element 10k (FIG. 10K) (step S20) according to the symbol shape data I1, a recognized result is generated and then the volume will be lowered (step S30).

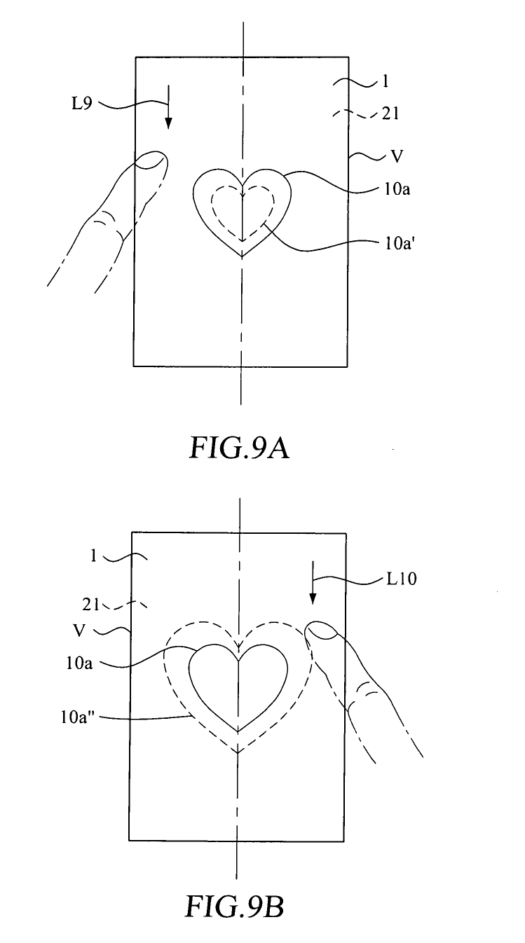

As referring to FIG. 8, which illustrates the inquiring action of the touch screen device 100 according to another embodiment of the present invention. A sliding symbol of a sliding trace L8 is formed by a user's finger sliding on the symbol element 10, and then the responding unit 42 inquires the unanswered calls and the communication history.

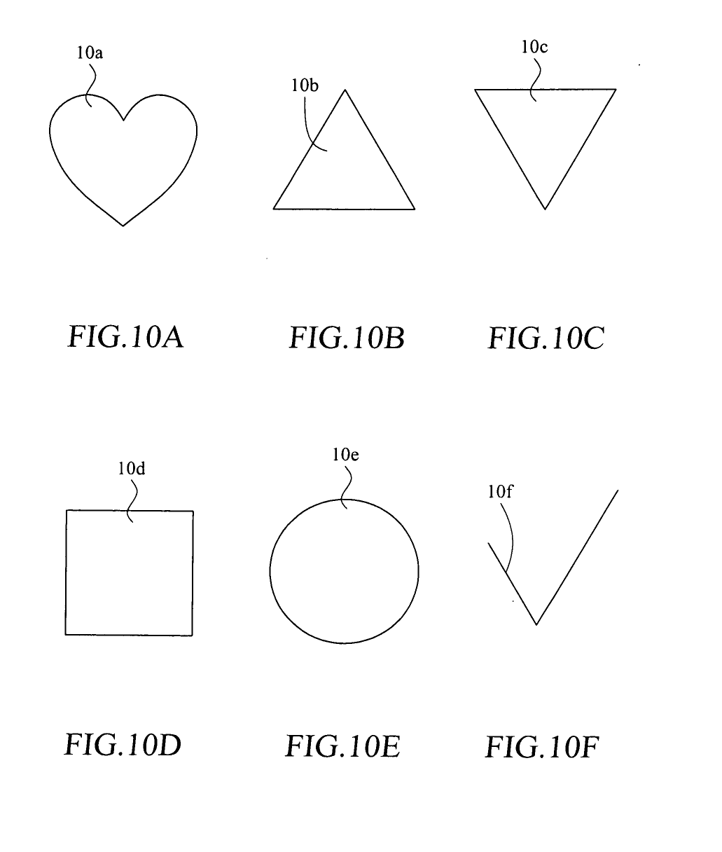

A zooming unit 43 is electrically connected to the trace recognizing unit 41, the zooming unit 43 performs a zooming operation according to a position of the sliding trace L recognized by the trace recognizing unit 41. For instance, when a sliding trace L9 is formed by a user's finger sliding on left-upper side of the touch control panel 21, the size of the word or the page of the displaying means 1 is zoomed out. In this embodiment, the symbol element 10a is zoomed out and becomes a symbol element 10a′ (step S30), as shown in FIG. 9A. When a sliding trace L10 is formed by a user's finger sliding on right-upper side of the touch control panel 21, the size of the word or the page of the displaying means 1 is zoomed in. In this embodiment, the symbol element 10a is zoomed in and then becomes a symbol element 10a″ (step S30), as shown in FIG. 9B.

As referring to FIGS. 10A to 10K, the symbol element 10 is displayed or hidden in the touch control panel 21. The displaying means 1 displays a heart-shaped symbol element 10a representing a favorite person (step S10), a triangle-shaped symbol element 10b representing a most frequently contacted supervisor, an inverted triangle-shaped symbol element 10c representing a most frequently contacted subordinate, a square-shaped symbol element 10d representing a most frequently contacted friend, a circle-shaped symbol element 10e representing a most frequently contacted family member, a hook-shaped symbol element 10f representing a person in a safe list, and a cross-shaped symbol element 10g representing a person in a rejection list. In addition, the frame-shaped one, bar-shaped one, dot-shaped one, polygon-shaped one can respectively represent the much frequently contacted classmates of elementary school, high school, university, and graduate school. A user can draw the symbol elements 10b, 10c, 10d, 10e, so as to respectively call the much frequently contacted supervisor, the much frequently contacted subordinate, the much frequently contacted friend, and the much frequently contacted family member.

The above description should be considered as only the discussion of the preferred embodiments of the present invention. However, a person skilled in the art may make various modifications to the present invention. Those modifications still fall within the spirit and scope defined by the appended claims.

What is claimed is:

1. A symbol-oriented touch screen device, comprising:
a displaying means with a viewing area for displaying a page;
a touch control panel coupled to the display means for detecting a sliding trace of an object on the touch control panel;
a symbol shape storing means being electrically connected to the displaying means and the touch control panel, the symbol shape storing means being stored with a symbol shape data in accordance with the page, wherein the symbol shape data is for determining shapes of a plurality of symbol elements; and
a hardware processing means including a trace recognizing unit and a responding unit, the hardware processing means electrically connected to the touch control panel and the symbol shape data storing means, the trace recognizing unit being provided for recognizing the sliding trace and for generating a recognized result while the sliding trace is matched with the symbol shape data, the responding unit electrically connected to the trace recognizing unit for performing a dialing action, an answering action, an inquiring action, and a controlling action in accordance with the recognized result.

2. The symbol-oriented touch screen device of claim 1, wherein the symbol element is with a frame-shape, a bar-shape, a dot-shape, a polygon-shape, a heart-shape, a circle-shape, a cross-shape, a hook-shape, or an arrow-shape.

3. The symbol-oriented touch screen device, of claim 1, wherein the symbol element is displayed or hidden in the touch control panel.

4. The symbol-oriented touch screen device of claim 1, wherein the trace recognizing unit includes a trace direction recognizing component for recognizing a direction of a sliding symbol of the sliding trace sliding across the symbol element.

5. The symbol-oriented touch screen device of claim 1, further comprising a position storing means for storing a symbol position data of the symbol element, wherein the symbol position data is for determining the position of the symbol element, and the recognized result is generated according to a position relationship between the sliding trace and the symbol element by the trace recognizing unit.

6. The symbol-oriented touch screen device of claim 1, further comprising a zooming unit electrically connected to the trace recognizing unit, the zooming unit performing a zooming operation according to a position of the sliding trace recognized by the trace recognizing unit.

7. The symbol-oriented touch screen device of claim 1, wherein the inquiring action is performed by the responding unit to inquire information including an unanswered call and a communication history when the slide trace is matched with an inquiring symbol of the symbol element.

8. The symbol-oriented touch screen device of claim 1, wherein the controlling action includes a control of volume adjustment by the responding unit when the sliding trace is matched with a symbol element of volume adjustment.
